(19) United States
(12) Patent Application Publication
(10) Pub. No.: US 2026/0039058 A1
(43) Pub. Date: Feb. 5, 2026

(54) CONNECTOR AND CONNECTOR ASSEMBLY

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Yangmin (Jonathan) Li, Shanghai (CN); Chunyan (Cherie) Zhou, Shanghai (CN); Jiandong (Dave) Wang, Shanghai (CN); Ky Zhu, Suzhou (CN); Pan Gong, Suzhou (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/286,566

(22) Filed: Jul. 31, 2025

(30) Foreign Application Priority Data
Jul. 31, 2024 (CN) 202411047368.3

(51) Int. Cl. H01R 13/629; H01R 12/70; H01R 12/72

(52) U.S. Cl. CPC H01R 13/62922; H01R 12/707; H01R 12/7082; H01R 12/721

(57) ABSTRACT

A connector includes a housing having a top wall and a bottom wall, a pair of side walls, and a front opening and a rear wall. Two rows of terminals having soldering ends extend backward from the rear wall of the housing. The connector includes two pressing plates including an upper pressing plate disposed on an upper side of the soldering ends of the upper row of terminals and a lower pressing plate disposed on a lower side of the soldering ends of the lower row of terminals. The two pressing plates slide from a pre-assembly position in which the soldering ends of the terminals are not pressed to a final assembly position in which the soldering ends of the terminals are pressed on the circuit board by the pushing of the circuit board.

### CROSS-REFERENCE TO RELATED APPLICATION

This application claims the benefit of the filing date under 35 U.S.C. § 119 (a)-(d) of Chinese Patent Application No. 202411047368.3, filed on Jul. 31, 2024.

### FIELD OF THE INVENTION

The present invention relates to a connector, and a connector assembly including the connector.

### BACKGROUND OF THE INVENTION

Terminals of a connector are typically soldered to surfaces of a circuit board in a surface-mounted manner. During soldering, the terminal of the connector comes into contact with solder paste on the circuit board under the own weight of the connector. After the solder paste is heated and molten, the molten liquid solder will climb onto the terminal by surface tension of the solder itself. After the liquid solder is cooled and solidified, soldering between the terminal and the circuit board is achieved.

However, during soldering, a housing of the connector relieves a residual stress and generates thermal expansion after being heated. This thermal expansion leads to the terminal being prone to movement in the heating process, and causes the terminal to be likely to be out of contact with the solder paste, such that the solder climbing cannot be completed, thereby forming a pseudo solder joint. This may reduce the soldering quality.

### SUMMARY OF THE INVENTION

A connector includes a housing having a top wall and a bottom wall, a pair of side walls, and a front opening and a rear wall. Two rows of terminals having soldering ends extend backward from the rear wall of the housing. The connector includes two pressing plates including an upper pressing plate disposed on an upper side of the soldering ends of the upper row of terminals and a lower pressing plate disposed on a lower side of the soldering ends of the lower row of terminals. The two pressing plates slide from a pre-assembly position in which the soldering ends of the terminals are not pressed to a final assembly position in which the soldering ends of the terminals are pressed on the circuit board by the pushing of the circuit board.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows an illustrative exploded view of a connector according to an exemplary embodiment of the present invention;

FIG. 3 shows a partial cross-sectional view of a connector according to an exemplary embodiment of the present invention;

FIG. 4 shows an illustrative perspective view of a connector assembly according to an exemplary embodiment of the present invention, with a pressing plate in a pre-assembly position;

FIG. 5 shows a side view of a connector assembly according to an exemplary embodiment of the present invention, with a pressing plate in a pre-assembly position;

FIG. 6 shows a cross-sectional view of a connector assembly according to an exemplary embodiment of the present invention, with a pressing plate in a pre-assembly position;

FIG. 7 shows an illustrative perspective view of a connector assembly according to an exemplary embodiment of the present invention, with a pressing plate in a final assembly position;

FIG. 8 shows a side view of a connector assembly according to an exemplary embodiment of the present invention, with a pressing plate in a final assembly position; and

FIG. 9 shows a cross-sectional view of a connector assembly according to an exemplary embodiment of the present invention, with a pressing plate in a final assembly position.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

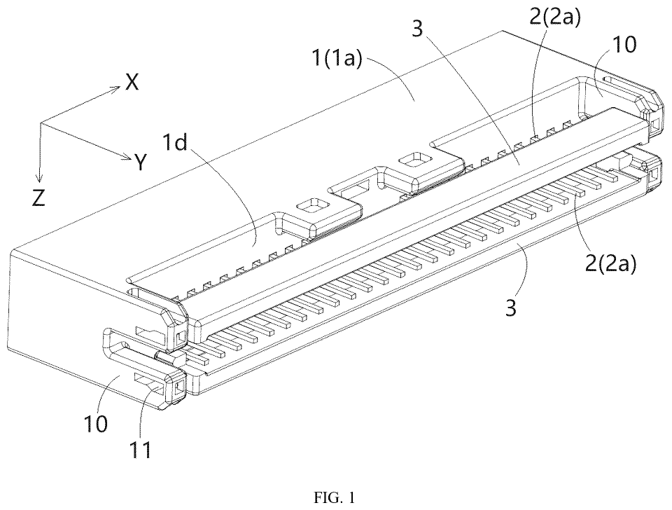

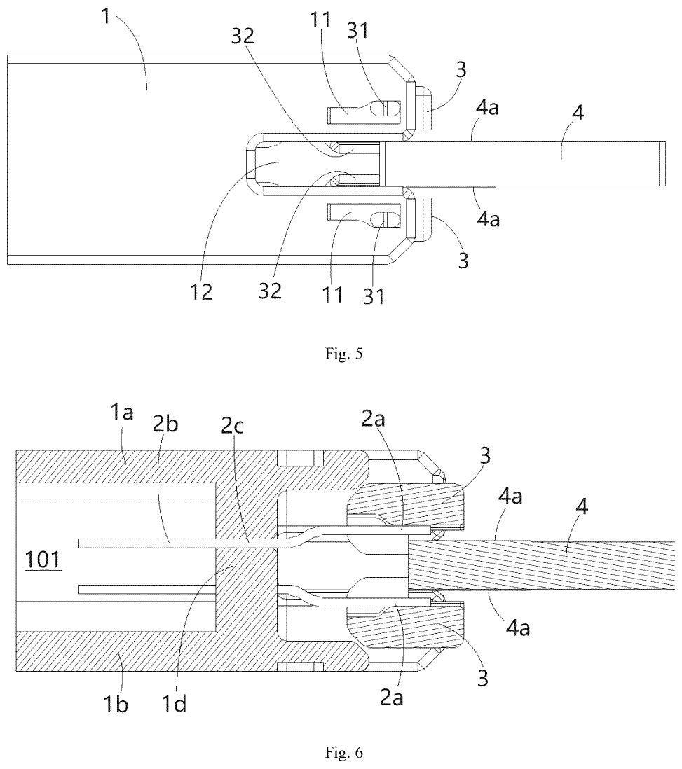

As shown in FIGS. 1 to 9, in an exemplary embodiment of the present invention, a connector is disclosed. The connector includes: a housing 1, upper and lower rows of terminals 2 and two pressing plates 3. The housing 1 has a top wall 1a and a bottom wall 1b opposite each other in a vertical direction Z, a pair of side walls 1c opposite each other in a transverse direction X, and a front opening and a rear wall 1d opposite each other in a longitudinal direction Y. The upper and lower rows of terminals 2 are disposed in the housing 1 and have soldering ends 2a extending backward from the rear wall 1d of the housing 1 and configured to be soldered to a circuit board 4. The two pressing plates 3 includes an upper pressing plate 3 disposed on an upper side of the soldering ends 2a of the upper row of terminals 2 and a lower pressing plate 3 disposed on a lower side of the soldering ends 2a of the lower row of terminals 2. A pair of vertical side plates 10 opposite each other in the transverse direction X are formed on the rear wall 1d of the housing 1, two guide slots 11 are formed in each of the vertical side plates 10, and the two guide slots 11 are in slidable engagement with protrusions 31 on end surfaces of the two pressing plates 3, respectively.

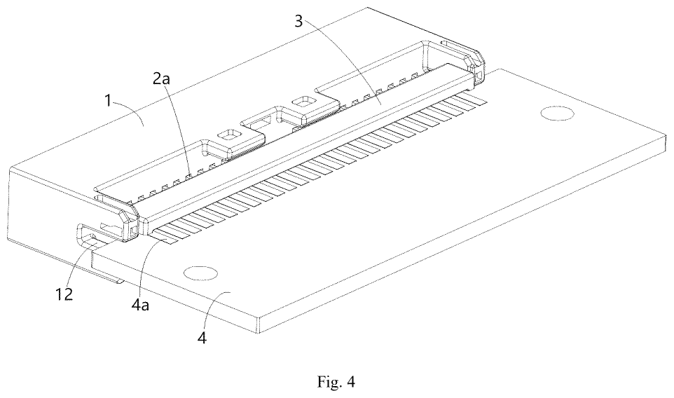

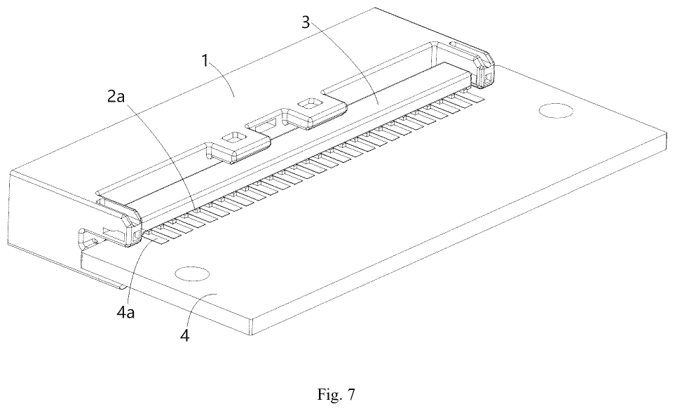

The two pressing plates 3 are adapted to slide along the guide slots 11 from a pre-assembly position (as shown in FIGS. 4-6) in which the soldering ends 2a of the terminals 2 are not pressed to a final assembly position (as shown in FIGS. 7-9) in which the soldering ends 2a of the terminals 2 are pressed on the circuit board 4 by the pushing of the circuit board 4 inserted between the soldering ends 2a of the two rows of terminals 2.

As shown in FIG. 6, in the illustrated embodiment, when the two pressing plates 3 are in the pre-assembly position, the soldering ends 2a of the two rows of terminals 2 are not in contact or have a contact force less than a predetermined value with soldering pads 4a on the inserted circuit board 4, to prevent the soldering ends 2a of the terminals 2 from scratching the soldering pads 4a on the inserted circuit board 4.

As shown in FIG. 9, in the illustrated embodiment, when the two pressing plates 3 are in the final assembly position, the soldering ends 2a of the two rows of terminals 2 are in contact with the soldering pads 4a on the inserted circuit board 4 by pressing of the two pressing plates 3, with the contact force greater than the predetermined value, to ensure that the soldering ends 2a of the terminals 2 are reliably soldered to the soldering pads 4a of the circuit board 4.

As shown in FIG. 1, in the illustrated embodiment, each of the guide slots 11 has a first end and a second end opposite each other in the longitudinal direction Y, and the second end of the guide slot 11 is closer to the rear wall 1d of the housing 1 than the first end. When the two pressing plates 3 as shown in FIGS. 4-6 are in the pre-assembly position, the protrusions 31 of the pressing plates 3 are located in the first ends of the guide slots 11. When the two pressing plates 3 are pushed to the final assembly position as shown in FIGS. 7-9 by the inserted circuit board 4, the protrusions 31 of the pressing plates 3 are moved into the second ends of the guide slots 11.

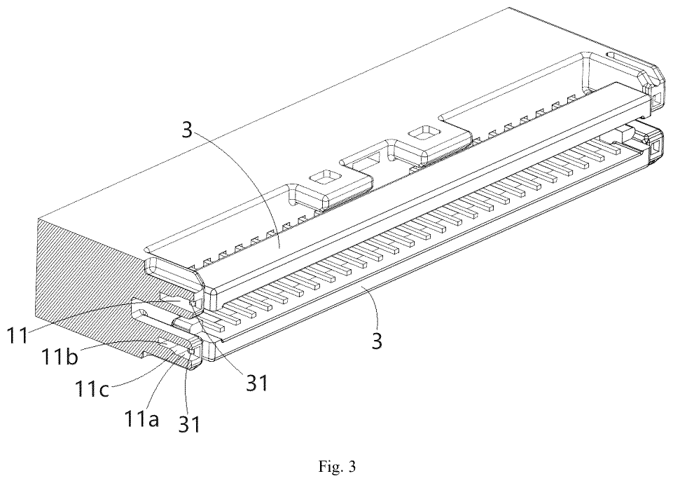

As shown in FIG. 3, in the illustrated embodiment, the guide slot 11 is formed with: a first guide surface 11a, a second guide surface 11b and a guide bevel 11c. The first guide surface 11a is located in the first end of the guide slot 11, extends in the longitudinal direction Y, and is configured to guide the protrusion 31 of the pressing plate 3 to move along the first guide surface. The second guide surface 11b is located in the second end of the guide slot 11, extends in the longitudinal direction Y, and is configured to guide the protrusion 31 of the pressing plate 3 to move along the second guide surface. The guide bevel 11c is located between the first end and the second end of the guide slot 11 and is configured to guide the protrusion 31 of the pressing plate 3 to move along the guide bevel 11c. The guide bevel 11c is connected between the first guide surface 11a and the second guide surface 11b to guide the protrusion 31 of the pressing plate 3 to move from the first guide surface 11a to the second guide surface 11b.

As shown in FIGS. 3, 5, and 6, in the illustrated embodiment, when the protrusion 31 of the pressing plate 3 moves along the first guide surface 11a, the pressing plate 3 does not press the soldering ends 2a of the terminals 2, such that the soldering ends 2a of the terminals 2 are not in contact with the soldering pads 4a on the inserted circuit board 4.

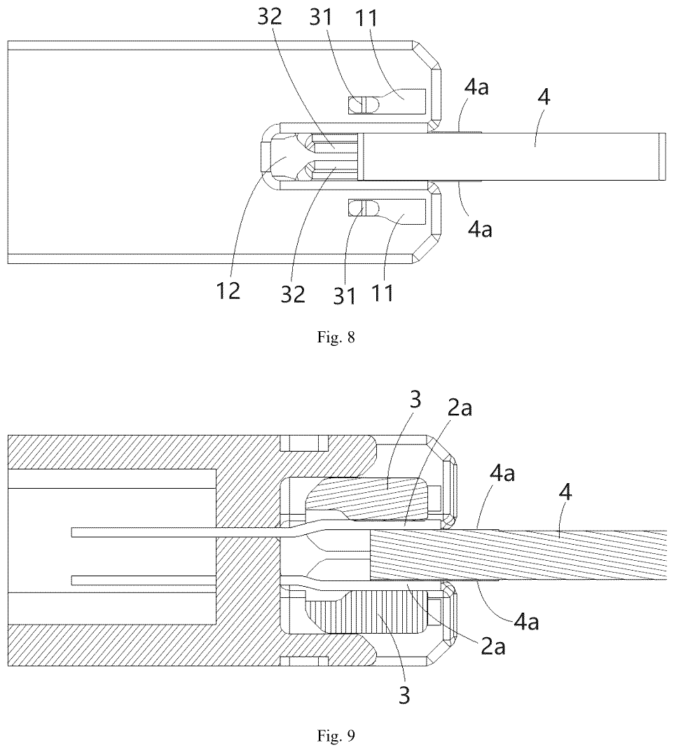

As shown in FIGS. 8 and 9, when the protrusion 31 of the pressing plate 3 moves along the second guide surface 11b, the pressing plate 3 presses the soldering ends 2a of the terminals 2, such that the soldering ends 2a of the terminals 2 are in contact with the soldering pads 4a on the inserted circuit board 4, with the contact force greater than the predetermined value.

When the protrusion 31 of the pressing plate 3 moves along the guide bevel 11c, the pressing plate 3 gradually moves from the pre-assembly position in which the soldering ends 2a of the terminals 2 are not pressed to the final assembly position in which the soldering ends 2a of the terminals 2 are pressed.

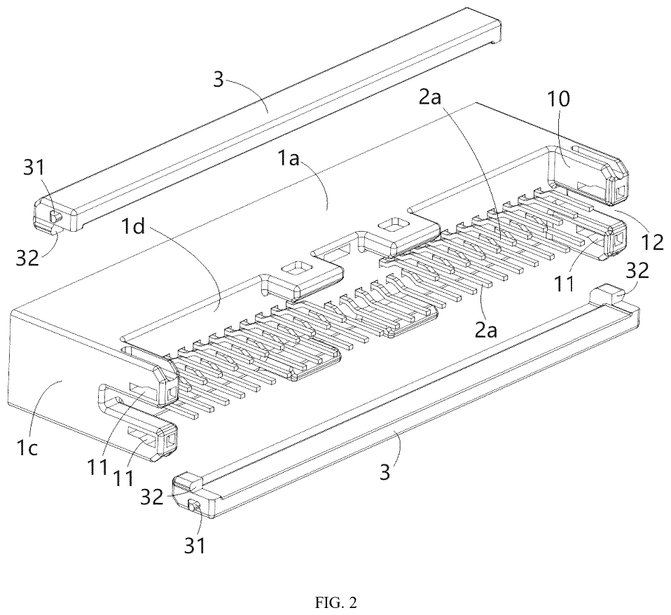

As shown in FIG. 2, in the illustrated embodiment, a step portion 32 is formed on each of two ends of the pressing plate 3, and the step portion 32 is configured to abut against a front end surface of the inserted circuit board 4, such that the pressing plate 3 moves from the pre-assembly position to the final assembly position along the guide slot 11 by the abutment and pushing of the inserted circuit board 4.

As shown in FIGS. 2 and 4, in the illustrated embodiment, an insertion slot 12 extending in the longitudinal direction Y is formed in the vertical side plate 10, and the two guide slots 11 in the vertical side plate 10 are arranged symmetrically on an upper side and a lower side of the insertion slot 12. Side edge portions of the circuit board 4 at two sides are adapted to be inserted into the insertion slots 12 of the pair of vertical side plates 10 respectively, to guide the circuit board 4 to be inserted between the soldering ends 2a of the two rows of terminals 2 in the longitudinal direction Y.

As shown in FIG. 1, in the illustrated embodiment, outer sides of the pair of vertical side plates 10 are respectively flush with outer side surfaces of the pair of side walls 1c of the housing 1, the upper sides and the lower sides of the pair of vertical side plates 10 are respectively flush with a top surface and a bottom surface of the housing 1, and the pair of vertical side plates 10 extend backward by a predetermined length in the longitudinal direction Y from rear sides of the pair of side walls 1c.

As shown in FIG. 6, in the illustrated embodiment, the top wall 1a, the bottom wall 1b, the pair of side walls 1c and the rear wall 1d of the housing 1 define an inner cavity 101, and the terminal 2 has a fixed portion 2c fixed in the rear wall 1d and a mating portion 2b located in the inner cavity 101 of the housing 1, the mating portion 2b of the terminal 2 is adapted to mate with a mating terminal of a mating connector inserted into the inner cavity 101 of the housing 1.

In another exemplary embodiment of the present invention, a connector assembly is also disclosed. The connector assembly includes: a connector as described in detail above and a circuit board 4. A row of soldering pads 4a are formed on each of a front side and a back side of the circuit board and are configured to be soldered to the soldering ends 2a of each of the two rows of terminals 2. The soldering ends 2a of the two rows of terminals 2 are soldered to the soldering pads 4a of the circuit board 4 after being pressed onto the soldering pads 4a of the circuit board 4 by the two pressing plates 3, to ensure that the soldering ends 2a of the terminals 2 are reliably soldered to the soldering pads 4a of the circuit board 4.

In the process of inserting the circuit board 4 between the soldering ends 2a of the two rows of terminals 2 of the connector, the two pressing plates 3 are pushed by the circuit board 4 to move along the guide slots 11 from the pre-assembly position in which the soldering ends 2a of the terminals 2 are not pressed to the final assembly position in which the soldering ends 2a of the terminals 2 are pressed on the circuit board 4.

In an embodiment, the connector assembly further includes a mating connector mating with the connector.

In the aforementioned exemplary embodiments according to the present invention, during soldering, the soldering ends of the terminals are reliably pressed on the soldering pads of the circuit board by the pressing plates, such that the reliable contact between the soldering ends of the terminals and the soldering pads of the circuit board can be ensured, thereby effectively avoiding the problem of pseudo soldering, and improving the soldering quality.

In addition, in the aforementioned exemplary embodiments according to the present invention, in the process of just inserting the circuit board, the soldering ends of the terminals do not come into contact or have a contact force less than a predetermined value with the soldering pads of the circuit board, such that the soldering pads on the circuit board can be effectively prevented from being scratched by the soldering ends of the terminals, and thus the soldering quality can be further improved.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a housing having a top wall and a bottom wall opposite each other in a vertical direction, a pair of side walls opposite each other in a transverse direction, and a front opening and a rear wall opposite each other in a longitudinal direction, a pair of vertical side plates opposite each other in the transverse direction are formed on the rear wall of the housing;
an upper row of terminals and a lower row of terminals disposed in the housing and having a plurality of soldering ends extending backward from the rear wall of the housing and solderable to a circuit board; and
a pair of pressing plates including an upper pressing plate disposed on an upper side of the soldering ends of the upper row of terminals and a lower pressing plate disposed on a lower side of the soldering ends of the lower row of terminals, the vertical side plates are in slidable engagement with the pressing plates, the pressing plates are slidable by pushing of the circuit board inserted between the soldering ends of the upper rows of terminals and the lower row of terminals and move from a pre-assembly position in which the soldering ends of the terminals are not pressed to a final assembly position in which the soldering ends of the terminals are pressed on the circuit board.

2. The connector according to claim 1, wherein a pair of guide slots are formed in each of the vertical side plates, the guide slots are in slidable engagement with a plurality of protrusions on an end surface of the pressing plates.

3. The connector according to claim 2, wherein, when the pressing plates are in a pre-assembly position, the soldering ends of the upper row of terminals and the lower row of terminals are not in contact or have a contact force less than a predetermined value with a plurality of soldering pads on the circuit board.

4. The connector according to claim 3, wherein, when the pressing plates are in a final assembly position, the soldering ends of the upper row of terminals and the lower row of terminals are in contact with the soldering pads on the circuit board by pressing of the pressing plates, with the contact force greater than the predetermined value.

5. The connector according to claim 4, wherein each of the guide slots has a first end and a second end opposite each other in the longitudinal direction, the second end of the guide slot is closer to the rear wall of the housing than the first end, and when the pressing plates are in the pre-assembly position, the protrusions of the pressing plates are located in the first ends of the guide slots.

6. The connector according to claim 5, wherein, when the pressing plates are pushed to the final assembly position by the circuit board, the protrusions of the pressing plates are moved into the second ends of the guide slots.

7. The connector according to claim 6, wherein the guide slot has:
a first guide surface located in the first end of the guide slot, extending in the longitudinal direction, and guiding one of the protrusions of the pressing plate to move along the first guide surface;
a second guide surface located in the second end of the guide slot, extending in the longitudinal direction, and guiding the one of the protrusions of the pressing plate to move along the second guide surface; and
a guide bevel located between the first end and the second end of the guide slot and guiding the one of the protrusions of the pressing plate to move along the guide bevel.

8. The connector according to claim 7, wherein the guide bevel is connected between the first guide surface and the second guide surface to guide the one of the protrusions of the pressing plate to move from the first guide surface to the second guide surface.

9. The connector according to claim 8, wherein, when the one of the protrusions of the pressing plate moves along the first guide surface, the pressing plate does not press the soldering ends of the terminals, and the soldering ends of the terminals are not in contact with the soldering pads on the circuit board.

10. The connector according to claim 8, wherein, when the one of the protrusions of the pressing plate moved along the second guide surface, the pressing plate presses the soldering ends of the terminals, and the soldering ends of the terminals are in contact with the soldering pads on the inserted circuit board, with the contact force greater than the predetermined value.

11. The connector according to claim 8, wherein, when the one of the protrusions of the pressing plate moves along the guide bevel, the pressing plate gradually moves from the pre-assembly position in which the soldering ends of the terminals are not pressed to the final assembly position in which the soldering ends of the terminals are pressed.

12. The connector according to claim 2, wherein a step portion is formed on each of a pair of ends of the pressing plate, the step portion abuts against a front end surface of the circuit board and the pressing plate moves from the pre-assembly position to the final assembly position along the guide slots by abutment and pushing of the circuit board.

13. The connector according to claim 2, wherein an insertion slot extending in the longitudinal direction is formed in each of the vertical side plates, the pair of guide slots in the vertical side plates are arranged symmetrically on an upper side and a lower side of the insertion slot.

14. The connector according to claim 13, wherein a pair of side edge portions of the circuit board are inserted into the insertion slots of the pair of vertical side plates to guide the circuit board to be inserted between the soldering ends of the upper row of terminals and the lower row of terminals in the longitudinal direction.

15. The connector according to claim 1, wherein a plurality of outer sides of the pair of vertical side plates are respectively flush with a plurality of outer side surfaces of the pair of side walls of the housing, a plurality of upper sides and a plurality of lower sides of the pair of vertical side plates are respectively flush with a top surface and a bottom surface of the housing, and the pair of vertical side plates extend backward by a predetermined length in the longitudinal direction from a pair of rear sides of the pair of side walls.

16. The connector according to claim 1, wherein the top wall, the bottom wall, the pair of side walls, and the rear wall of the housing define an inner cavity, each of the terminals has a fixed portion fixed in the rear wall and a mating portion located in the inner cavity of the housing, the mating portion of the terminals is matable with a mating terminal of a mating connector inserted into the inner cavity of the housing.

17. A connector assembly, comprising:
a connector including:
a housing having a top wall and a bottom wall opposite each other in a vertical direction, a pair of side walls opposite each other in a transverse direction, and a front opening and a rear wall opposite each other in a longitudinal direction, a pair of vertical side plates opposite each other in the transverse direction are formed on the rear wall of the housing;
an upper row of terminals and a lower row of terminals disposed in the housing and having a plurality of soldering ends extending backward from the rear wall of the housing; and
a pair of pressing plates including an upper pressing plate disposed on an upper side of the soldering ends of the upper row of terminals and a lower pressing plate disposed on a lower side of the soldering ends of the lower row of terminals, the vertical side plates are in slidable engagement with the pressing plates; and
a circuit board, a row of soldering pads formed on each of a front side and a back side of the circuit board and soldered to the soldering ends of the upper row of terminals and the lower row of terminals, the pressing plates are slidable by pushing of the circuit board inserted between the soldering ends of the upper rows of terminals and the lower row of terminals and movable from a pre-assembly position in which the soldering ends of the terminals are not pressed to a final assembly position in which the soldering ends of the terminals are pressed on the circuit board, the soldering ends of the upper row of terminals and the lower row of terminals are soldered to the soldering pads of the circuit board after being pressed onto the soldering pads of the circuit board by the pressing plates.

18. The connector assembly according to claim 17, wherein, while inserting the circuit board between the soldering ends of the upper row of terminals and a lower row of terminals of the connector, the pressing plates are pushed by the circuit board to move along a plurality of guide slots of the vertical side plates from the pre-assembly position to the final assembly position.

19. The connector assembly according to claim 18, further comprising a mating connector mating with the connector.
